(19) United States
(12) Patent Application Publication
(10) Pub. No.: US 2022/0351665 A1
(43) Pub. Date: Nov. 3, 2022

(54) DISPLAY PANEL AND DISPLAY DEVICE

(71) Applicant: TCL CHINA STAR OPTOELECTROINCS TECHNOLOGY CO., LTD., Shenzhen, Guangdong (CN)

(72) Inventor: Jinfeng LIU, Shenzhen, Guangdong (CN)

(21) Appl. No.: 16/973,369

(22) PCT Filed: Nov. 17, 2020
(86) PCT No.: PCT/CN2020/129384

§ 371 Date: Dec. 8, 2020

(30) Foreign Application Priority Data
Oct. 21, 2020 (CN) 202011132287.5

(51) Int. Cl. G09G 3/20

(52) U.S. Cl. CPC G09G 3/2092; G09G 2310/08; G09G 2310/0275; G09G 2330/06; G09G 2330/021

(57) ABSTRACT

The present invention provides a display panel and a display device. The first enable sub-signal and the second enable sub-signal output by the timing controller are modulated by the logic controller to generate a plurality of enable signals with sequentially changing phases, which can control data signals in a source driver chip to time-sharingly output by multiple sets. This reduces a load capacity of the source driver chip, which is beneficial to reducing costs of the source driver chip. The time-sharing output of the source driver chip can reduce a peak current of each output channel, thus reducing power consumption and lowering the risk of electromagnetic interference (EMI).

### FIELD OF INVENTION

The present invention relates to the field of display technology and in particular to the field of data driving technology, specifically to a display panel and a display device.

### BACKGROUND OF INVENTION

In traditional technical solutions, a timing controller controls a source driver to output data signals of all channels to corresponding data lines at the same time through an enable signal, resulting in currents of each data signal in the source driver peaking at the same time. This not only requires a source driver with a higher load capacity, but also increases power consumption of the source driver and increases the risk of serious electromagnetic interference (EMI).

### SUMMARY

The present invention provides a display panel and a display device, which solves the problem below: a source driver chip controlled by a timing controller to output all data signals at the same time requires a higher loading capacity, an issue of power consumption, and the risk of serious EMI.

In a first aspect, the present invention provides a display panel, which comprises a timing controller, a logic controller, and at least one source driver chip. The timing controller is configured to generate a first enable sub-signal and a second enable sub-signal; the logic controller is connected to the timing controller and configured to generate N numbers of enable signals with sequentially changing phases according to the first enable sub-signal and the second enable sub-signal; and the at least one source driver chip is connected to the logic controller and configured to time-sharingly output N numbers of sets of data signals according to the enable signals. N is an integer greater than or equal to 2.

Based on the first aspect, in a first implementation of the first aspect, a rising edge of a first enable signal is generated in response to a first rising edge of the first enable sub-signal, and a falling edge of the first enable signal is generated in response to a first falling edge of the second enable sub-signal; and a rising edge of a second enable signal is generated in response to a second rising edge of the first enable sub-signal, and a falling edge of the second enable signal is generated in response to a second falling edge of the second enable sub-signal.

Based on the first implementation of the first aspect, in a second implementation of the first aspect, a time interval between a first rising edge of the first enable signal and a first rising edge of the second enable signal is a first period of the first enable sub-signal.

Based on the second implementation of the first aspect, in a third implementation of the first aspect, a time interval between a first falling edge of the first enable signal and a first falling edge of the second enable signal is a second period of the second enable sub-signal.

Based on the third implementation of the first aspect, in a fourth implementation of the first aspect, an adjustable delay is defined between the first rising edge of the first enable sub-signal and the first falling edge of the second enable sub-signal.

Based on the third implementation of the first aspect, in a fifth implementation of the first aspect, the first period and the second period are the same or different.

Based on the first aspect, in a sixth implementation of the first aspect, the source driver chip stores corresponding data signals in response to a rising edge of the enable signal.

Based on the sixth implementation of the first aspect, in a seventh implementation of the first aspect, the source driver chip outputs corresponding data signals in response to a rising edge of the enable signal.

Based on any of the foregoing implementations of the first aspect, in the eighth implementation of the first aspect, each of the enable signals correspondingly controls a set of the data signals.

In a second aspect, the present invention provides a display device, which comprises a plurality of data lines and the display panel of any of the implementations in the first aspect. The plurality of data lines is configured to correspondingly transmit the data signals.

In the display panel and the display device provided by the present invention, the first enable sub-signal and the second enable sub-signal output by the timing controller are modulated by the logic controller to generate a plurality of enable signals with sequentially changing phases, which can control the data signals in the source driver chip to time-sharingly output by multiple sets. This reduces the load capacity of the source driver chip, which is beneficial to reduce a cost of the source driver chip. The time-sharingly output of the source driver chip can reduce a peak current of each output channel, thus reducing power consumption and lowering or eliminating the risk of EMI.

### DESCRIPTION OF DRAWINGS

FIG. 1 is a schematic structural diagram of a display panel in accordance with an embodiment of the present invention.

FIG. 2 is a schematic diagram of a corresponding relationship between an enable sub-signal and an enable signal in FIG. 1.

FIG. 3 is a schematic diagram of a corresponding simulation of an enable signal and a data signal in accordance with an embodiment of the present invention.

### DETAILED DESCRIPTION OF EMBODIMENTS

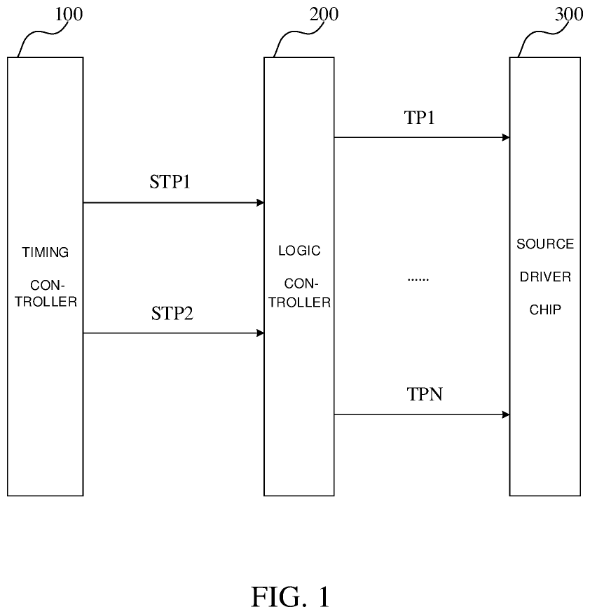

As shown in FIG. 1, the present embodiment provides a display panel, which comprises a timing controller 100, a logic controller 200, and at least one source driver chips 300. The timing controller 100 outputs a generated first enable sub-signal STP1 and a generated second enable sub-signal STP2 to two input terminals of the logic controller 200. The logic controller 200 generates N number of enable signals with sequentially changing phases according to the first enable sub-signal STP1 and the second enable sub-signal STP2. For example, a first enable signal TP1 to the Nth enable signal TPN. The N number of enable signals are output to at least one source driver chip 300, and the source driver chip 300 controls data signals in all output channels according to the corresponding enable signals, so as to time-sharingly output the enable signals in N number of sets. N is an integer greater than or equal to 2.

It should be noted that, a number of the source driver chips 300 can be, but are not limited to, one. When the number of output channels of one source driver chip 300 cannot meet requirements of the display panel, multiple source driver chips 300 can be used by simply correspondingly adjust the number of enable signals output by the logic controller 200. When multiple source driver chips 300 are used, a set of data signals of the first source driver chip 300 can be, but are not limited to, being synchronously output with a set of data signals of the second source driver chip 300, which can save output time and improve work efficiency of the display panel. It can also be the same as an output timing of the data signals in a source driver chip 300, that is, the output is sequentially time-sharing, and after the first source driver chip 300 outputs, the second source driver chip 300 outputs.

The enable signals with sequentially changing phases can be understood as phases from the first enable signal to the Nth enable signal delaying or advancing sequentially, so as to time-sharingly control the source driver chip 300 to output different sets of data signals. Regarding the grouping of data signals, data signals in a same set may be, but are not limited to be, output by adjacent output channels. They may also be output by discrete output channels, or both. The number of digital signals in each set can be, but is not limited to, the same, and the individual number of digital signals in each set can also be configured by itself. Each enable signal correspondingly controls a set of data signals. For example, an enable signal can simultaneously control a set of data signals for storage or output.

It can be understood that, the first enable sub-signal STP1 and the second enable sub-signal STP2 output by the timing controller 100 are modulated by the logic controller 200 to generate a plurality of enable signals with sequentially changing phases, which can control the data signals in the source driver chip 300 to time-sharingly output by multiple sets. This reduces the load capacity of the source driver chip 300, which is beneficial to reduce a cost of the source driver chip 300. The time-sharingly output of the source driver chip 300 can reduce a peak current of each output channel, thus reducing power consumption and lowering or eliminating the risk of electromagnetic interference (EMI).

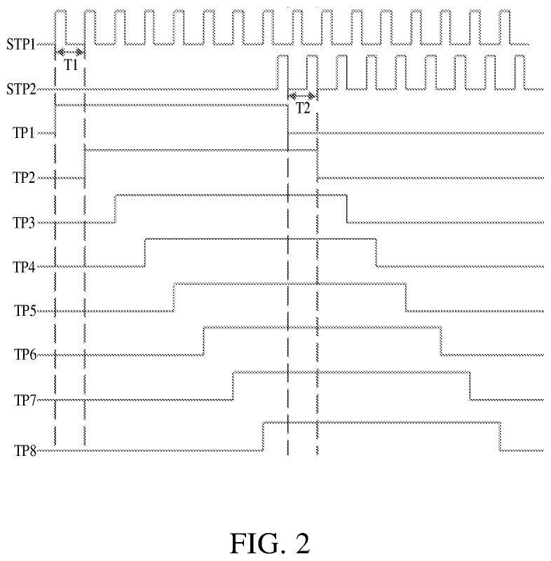

As shown in FIG. 2, in one of the embodiments, a rising edge of a first enable signal TP1 is generated in response to a first rising edge of the first enable sub-signal STP1, and a falling edge of the first enable signal TP1 is generated in response to a first falling edge of the second enable sub-signal STP2; and a rising edge of a second enable signal TP2 is generated in response to a second rising edge of the first enable sub-signal STP1, and a falling edge of the second enable signal TP2 is generated in response to a second falling edge of the second enable sub-signal STP2. In the same way, it can be known that other enable signals can also be generated in this manner, thus a degree of concentration is high, which facilitates the integration of the logic controller 200 into the display panel or the timing controller 100, thereby saving a space occupied by the display panel.

A time interval between a first rising edge of the first enable signal TP1 and a first rising edge of the second enable signal TP2 is a first period T1 of the first enable sub-signal STP1. That is, a duration of the first period T1 can define the time interval between the rising edges of two adjacent output enable signals.

A time interval between a first falling edge of the first enable signal TP1 and a first falling edge of the second enable signal TP2 is a second period T2 of the second enable sub-signal STP2. That is, a duration of the first period T1 can define the time interval between the falling edges of two adjacent output enable signals.

In one of the embodiments, the first period T1 and the second period T2 may be, but are not limited to be, the same; they may also be different. For example, the first period T1 is greater than the second period T2, or the second period T2 is greater than the first period T2.

In one of the embodiments, an adjustable delay is defined between the first rising edge of the first enable sub-signal STP1 and the first falling edge of the second enable sub-signal STP2.

It can be understood that, the timing controller 100 can modulate a delay between the first rising edge of the first enable sub-signal STP1 and the first falling edge of the second enable sub-signal STP2 as required, and the logic controller 200 generate the corresponding enable signal accordingly.

In one of the embodiments, the source driver chip 300 stores corresponding data signals in response to a rising edge of the enable signal.

In one of the embodiments, the source driver chip 300 outputs corresponding data signals in response to a rising edge of the enable signal.

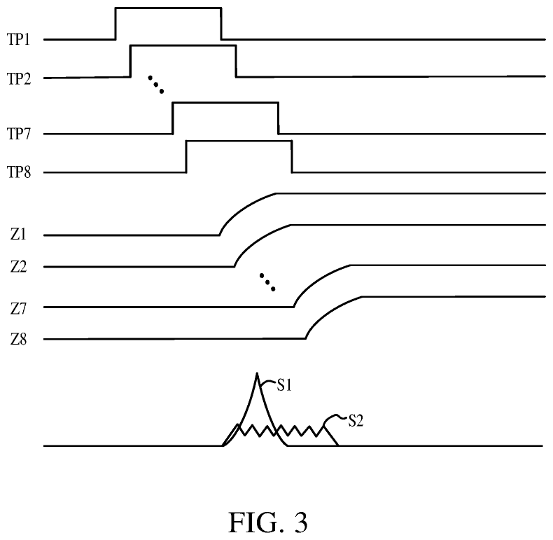

Referring to FIG. 2 and FIG. 3, in one of the embodiments, based on the above considerations and taking N=8 as an example, when a first rising edge of the first enable sub-signal STP1 comes, a first enable signal TP1 is pulled up to a high level; when a second rising edge of the first enable sub-signal STP1 comes, a second enable signal TP2 is pulled up to a high level; when a third rising edge of the first enable sub-signal STP1 comes, a third enable signal TP3 is pulled up to a high level; when a fourth rising edge of the first enable sub-signal STP1 comes, a fourth enable signal TP4 is pulled up to a high level; when a fifth rising edge of STP1 comes, a fifth enable signal TP5 is pulled up to a high level; when a sixth rising edge of the first enable sub-signal STP1 comes, a sixth enable signal TP6 is pulled up to a high level; when a seventh rising edge of the first enable sub-signal STP1 comes, a seventh enable signal TP7 is pulled up to a high level; until an eighth rising edge of the first enable sub-signal STP1 comes, the eighth enable signal TP8 is pulled up to a high level. At the same time, when a first falling edge of the second enable sub-signal STP2 comes, the first enable signal TP1 is pulled down from the high level to a low level; when a second falling edge of the second enable sub-signal STP2 comes, the second enable signal TP2 is pulled down from the high level to a low level; when a third falling edge of the second enable sub-signal STP2 comes, the third enable signal TP3 is pulled down from the high level to a low level; when a fourth falling edge of the second enable sub-signal STP2 comes, the fourth enable signal TP4 is pulled down from the high level to a low level; when a fifth falling edge of the second enable sub-signal STP2 comes, the fifth enable signal TP5 is pulled down from the high level to a low level; when a sixth falling edge of the second enable sub-signal STP2 comes, the sixth enable signal TP6 is pulled down from the high level to a low level; when a seventh falling edge of the second enable sub-signal STP2 comes, the seventh enable signal TP7 is pulled down from the high level to a low level; until an eighth falling edge of the second enable sub-signal STP2 comes, the seventh enable signal TP8 is pulled down from the high level to a low level. According to the above-mentioned mechanism, the logic controller 200 generates enable signals for time-sharing output.

As shown in FIG. 3, assuming that the number of output channels/data signals of a source driver chip 300 totals 960, if they are correspondingly divided into 8 evenly distributed sets, each set has 120 output channels/data signals. When the falling edge of the first enable signal TP1 comes, the output channels Z1 of the first set output the data signals; when the falling edge of the second enable signal TP2 comes, the output channels Z2 of the second set output the data signals; as such, when the falling edge of the seventh enable signal TP7 comes, the output channels Z7 of the seventh set output the data signals; and when the falling edge of the eighth enable signal TP8 comes, the output channels Z8 of the eighth set output the data signals. An enable signal correspondingly controls a set of output channel/data signals, and there is a certain delay between each two adjacent enable signals to realize the source driver chip 300 outputting at different times, so division of peak currents may be achieved. For example, the peak of an original current curve S1 is sharp and high, while the peak of the processed current curve S2 in the present embodiment is relatively flat and much lower than the previous height.

It can be seen that a principle of this method is simple, that the method does not require complicated circuit modules or algorithms, that it is simple to implement, and that it is widely applicable.

In one of the embodiments, the present invention provides a display device, which comprises a plurality of data lines and the display panel of any of the above embodiments. The plurality of data lines is configured to correspondingly transmit the data signals.

It can be understood that, since the display device comprises at least the display panel in any of the above-mentioned embodiments, the first enable sub-signal STP1 and the second enable sub-signal STP2 output by the timing controller 100 are modulated by the logic controller 200 to generate a plurality of enable signals with sequentially changing phases, which can control the data signals in the source driver chip 300 to time-sharingly output by multiple sets. This reduces the load capacity of the source driver chip 300, which is beneficial to reducing costs of the source driver chip 300. The time-sharing output of the source driver chip 300 can reduce a peak current of each output channel, thus reducing power consumption and lowering or eliminating the risk of EMI.

To make the objectives, technical solutions, and effects of the present invention more clear and specific, the present invention is described in further detail below with reference to the embodiments accompanying with drawings. It should be understood that the specific embodiments described herein are merely for explaining the present invention, and the present invention is not limited thereto.

It can be understood that, for those skilled in the art, equivalent replacements and modifications can be made according to the technical solution and disclosure ideas thereof of the present invention, and all these modifications or replacements are considered within the protection scope of the attached claims of the present invention.

What is claimed is:

1. A display panel, comprising:
a timing controller configured to generate a first enable sub-signal and a second enable sub-signal;
a logic controller connected to the timing controller and configured to generate N number of enable signals with sequentially changing phases according to the first enable sub-signal and the second enable sub-signal; and
at least one source driver chip connected to the logic controller and configured to time-sharingly output N number of sets of data signals according to the enable signals,
wherein N is an integer greater than or equal to 2.

2. The display panel as claimed in claim 1, wherein a rising edge of a first enable signal is generated in response to a first rising edge of the first enable sub-signal, and a falling edge of the first enable signal is generated in response to a first falling edge of the second enable sub-signal; and
a rising edge of a second enable signal is generated in response to a second rising edge of the first enable sub-signal, and a falling edge of the second enable signal is generated in response to a second falling edge of the second enable sub-signal.

3. The display panel as claimed in claim 2, wherein a time interval between a first rising edge of the first enable signal and a first rising edge of the second enable signal is a first period of the first enable sub-signal.

4. The display panel as claimed in claim 3, wherein a time interval between a first falling edge of the first enable signal and a first falling edge of the second enable signal is a second period of the second enable sub-signal.

5. The display panel as claimed in claim 4, wherein an adjustable delay is defined between the first rising edge of the first enable sub-signal and the first falling edge of the second enable sub-signal.

6. The display panel as claimed in claim 4, wherein the first period and the second period are the same or different.

7. The display panel as claimed in claim 1, wherein the source driver chip stores corresponding data signals in response to a rising edge of the enable signal.

8. The display panel as claimed in claim 7, wherein the source driver chip outputs corresponding data signals in response to a rising edge of the enable signal.

9. The display panel as claimed in claim 1, wherein one of the enable signals correspondingly controls a group of the data signals.

10. A display device, comprising:
the display panel as claimed in claim 1; and
a plurality of data lines configured to correspondingly transmit the data signals.

11. The display device as claimed in claim 10, wherein a rising edge of a first enable signal is generated in response to a first rising edge of the first enable sub-signal, and a falling edge of the first enable signal is generated in response to a first falling edge of the second enable sub-signal; and
a rising edge of a second enable signal is generated in response to a second rising edge of the first enable sub-signal, and a falling edge of the second enable signal is generated in response to a second falling edge of the second enable sub-signal.

12. The display device as claimed in claim 11, wherein a time interval between a first rising edge of the first enable signal and a first rising edge of the second enable signal is a first period of the first enable sub-signal.

13. The display device as claimed in claim 12, wherein a time interval between a first falling edge of the first enable signal and a first falling edge of the second enable signal is a second period of the second enable sub-signal.

14. The display device as claimed in claim 13, wherein an adjustable delay is defined between the first rising edge of the first enable sub-signal and the first falling edge of the second enable sub-signal.

15. The display panel as claimed in claim 13, wherein the first period and the second period are same or different.

16. The display device as claimed in claim 10, wherein the source driver chip stores corresponding data signals in response to a rising edge of the enable signal.

17. The display device as claimed in claim 16, wherein the source driver chip outputs corresponding data signals in response to a rising edge of the enable signal.

18. The display device as claimed in claim 10, wherein one of the enable signals correspondingly controls a group of the data signals.
